(19) United States
(12) Patent Application Publication
(10) Pub. No.: US 2011/0020674 A1
(43) Pub. Date: Jan. 27, 2011

(54) ENCLOSED BATTERY

(76) Inventor: Hideaki Fujita, Osaka (JP)

Correspondence Address: MCDERMOTT WILL & EMERY LLP, 600 13TH STREET, NW, WASHINGTON, DC, 20005-3096, US

(21) Appl. No.: 12/376,510

(22) PCT Filed: Jun. 19, 2007
(86) PCT No.: PCT/JP2007/002406

§ 371 Date: Feb. 5, 2009

(30) Foreign Application Priority Data
Aug. 10, 2006 (JP) 2006-218065

(51) Int. Cl. H01M 2/12

(52) U.S. Cl. 429/53

(57) ABSTRACT

A cylindrical electrode group prepared by winding a positive electrode and a negative electrode with a separator interposed therebetween is placed in a rectangular battery case together with an electrolyte. A pressure release mechanism is provided on a bottom surface of the battery case parallel to a winding axis of the electrode group. The pressure release mechanism is spaced apart from a projection line of the winding axis of the electrode group projected at a right angle on the bottom surface of the battery case.

### TECHNICAL FIELD

The present invention relates to an enclosed battery capable of ensuring high safety even in the case of inner pressure increase in the battery.

### BACKGROUND ART

In the market, the extent of enclosed batteries, particularly chargeable/dischargeable enclosed secondary batteries, are increasing. They are used as a power source for devices such as cellular phones and personal computers in a field where high energy density batteries ready for reduction in size and weight are required, or as a power source for electric tools and hybrid cars in a field where high power batteries are required. Specifically, in the field where high power batteries are required, the enclosed batteries are designed so as to reduce an internal resistance as much as possible. Therefore, when a short circuit is caused between a positive electrode and a negative electrode by an internal factor such as foreign substances present in the battery or an external factor such as an external pressure, large current flows locally through the short-circuited part and resulting heat generation increases the pressure in the battery. As a result, a battery case or a joint such as a sealing plate may be broken.

As an approach to this problem, a safety valve is provided on a lid of the battery case. When the pressure in the battery is abnormally increased, the safety valve is actuated to emit gas out of the battery so that break of the battery case is prevented from occurring (e.g., see Patent Literature 1).

However, on the lid of the battery case, electrode terminals are also provided. Therefore, the size of the safety valve is limited due to space limitations. For example, when the safety valve is provided by thinning part of the lid, it is necessary to perform the thinning to such a degree that a certain working pressure is surely obtained under the limitation of the valve size on one hand, but it is also necessary to ensure a certain thickness that prevents the thinned part from being broken by impact when the battery is dropped on the other hand.

Patent Literature 2 describes a safety valve formed on a battery case without such limitations. Specifically, a thinned part in the form of a groove is formed on the surface of the battery case as a safety valve capable of being actuated at a certain working pressure without any space limitations. The safety valve is designed to have predetermined thickness and length so that the safety valve is broken when the pressure in the battery case is increased and the battery case is deformed. In addition, the safety valve is highly resistive against drop impact as it is formed in part of the battery case which is less likely to receive drop impact.

### [Patent Literature 1] Publication of Japanese Patent Publication No. 10-106524

### [Patent Literature 2] Publication of Japanese Patent Publication No. 11-185714

### DISCLOSURE OF THE INVENTION

### Problem that the Invention is to Solve

The safety valve described in Patent Literature 2 may advantageously increase the design flexibility as it can be arranged without space limitations. However, since the thinned part in the form of the groove is supposed to be broken when the battery case is deformed, the thickness and length of the groove have to be changed as the position of the safety valve is changed. Therefore, the design is complicated.

Further, when the pressure in the battery is abnormally increased, the safety valve is actuated to emit gas out of the battery so as to prevent the break of the battery case. However, if an excess of an electrolyte which has not penetrated into the electrode group remains in the battery case, and the temperature in the battery case is still high (a response speed of temperature decrease is considerably lower than that of gas emission), the flammable electrolyte may be heated to raise the temperature in the battery case to a further extent.

In view of the foregoing, the present invention has been achieved. A principle object of the present invention is to provide a highly safety enclosed battery provided with a pressure release mechanism capable of quickly emitting gas out of the battery when an abnormal event occurs and the pressure in the battery is increased.

The present invention further provides an enclosed battery having a high level of safety and provided with a pressure release mechanism capable of quickly emitting gas generated in the battery and quickly draining an electrolyte remaining in the battery out of the battery when an abnormal event occurs.

### Means of Solving the Problem

In order to solve the problem, an enclosed battery of the present invention includes a cylindrical electrode group which is prepared by winding a positive electrode and a negative electrode with a separator interposed therebetween and placed in a rectangular battery case together with an electrolyte, wherein a pressure release mechanism is provided on a side surface of the battery case parallel to a winding axis of the electrode group, and the pressure release mechanism is spaced apart from a projection line of the winding axis of the electrode group projected at a right angle on the side surface.

Regarding the enclosed battery of the present invention, a region inside the battery case defined between the cylindrical electrode group and inner surfaces of the side surfaces of the battery case parallel to the winding axis of the electrode group forms empty space large enough to ensure a working pressure when an abnormal event occurs. Therefore, the pressure release mechanism is disposed on the side surface of the battery case corresponding to the empty space, i.e., on the side surface of the battery case parallel to the winding axis of the electrode group to be spaced apart from a projection line of the winding axis of the electrode group projected at a right angle on the side surface of the battery case. As a result, gas generated in the battery under the abnormal conditions is surely and quickly emitted out of the battery.

In a preferred embodiment, a terminal of the positive electrode and a terminal of the negative electrode are provided on a first side surface of the side surfaces parallel to the winding axis of the electrode group, and the pressure release mechanism is provided on a second side surface facing the first side surface.

In a preferred embodiment, a terminal of the positive electrode and a terminal of the negative electrode are provided on a first side surface of the side surfaces parallel to the winding axis of the electrode group, and the pressure release mechanism is provided on a third side surface adjoining to the first side surface and spaced apart from the projection line projected on the third side surface in a direction opposite the first side surface.

When a battery is loaded on a device or an electric car, the first surface on which the electrode terminals are provided is generally regarded as a top surface of the battery case (a surface opposite the ground). Therefore, by providing the pressure release mechanism on the second surface facing the first surface, i.e., on a bottom surface (a surface in contact with the ground), gas generated in the battery under the abnormal conditions is quickly emitted out of the battery, and at the same time, an electrolyte remaining in the battery is quickly drained out of the battery.

In the case where the pressure release mechanism is provided on a third side surface adjoining to the first side surface and spaced apart from the projection line projected on the third side surface in a direction opposite the first side surface, i.e., spaced apart from the projection line toward the bottom surface, gas generated in the battery under the abnormal conditions is quickly emitted out of the battery and an electrolyte remaining near the bottom of the battery case is quickly drained out of the battery.

### EFFECT OF THE INVENTION

The present invention provides a highly safety enclosed battery including a pressure release mechanism capable of quickly emitting gas out of the battery when an abnormal event occurs and the pressure in the battery is increased.

The present invention further provides a highly safety enclosed battery including a pressure release mechanism capable of emitting gas out of the battery and quickly draining an electrolyte remaining in the battery out of the battery when an abnormal event occurs.

### BRIEF DESCRIPTION OF DRAWINGS

FIGS. 1A to 1D are views illustrating the structure of an enclosed battery according to an embodiment of the present invention. FIG. 1A is a top view, FIG. 1B is a front perspective view, FIG. 1C is a side perspective view and FIG. 1D is a bottom view.

FIGS. 2A to 2C are views illustrating the arrangement of a pressure release mechanism according to the present invention.

FIG. 3 is a view illustrating the structure of a conventional cylindrical lithium ion secondary battery.

### EXPLANATION OF REFERENCE NUMERALS

1 Electrode group
2 Positive electrode current collector plate
3 Negative electrode current collector plate
4 Positive electrode terminal
5 Negative electrode terminal
6 Lid
7 Insulator
8 Battery case
9 Injection hole
10 Safety valve (pressure release mechanism)
11 Empty space
12 Top surface
13 Bottom surface
14 Side surface

### BEST MODE FOR CARRYING OUT THE INVENTION

Hereinafter, an embodiment of the present invention will be described below with reference to the drawings. In the following drawings, the same reference numerals are assigned to components having substantially the same functions for the sake of simple explanation. It is noted that the present invention is not limited to the following embodiment.

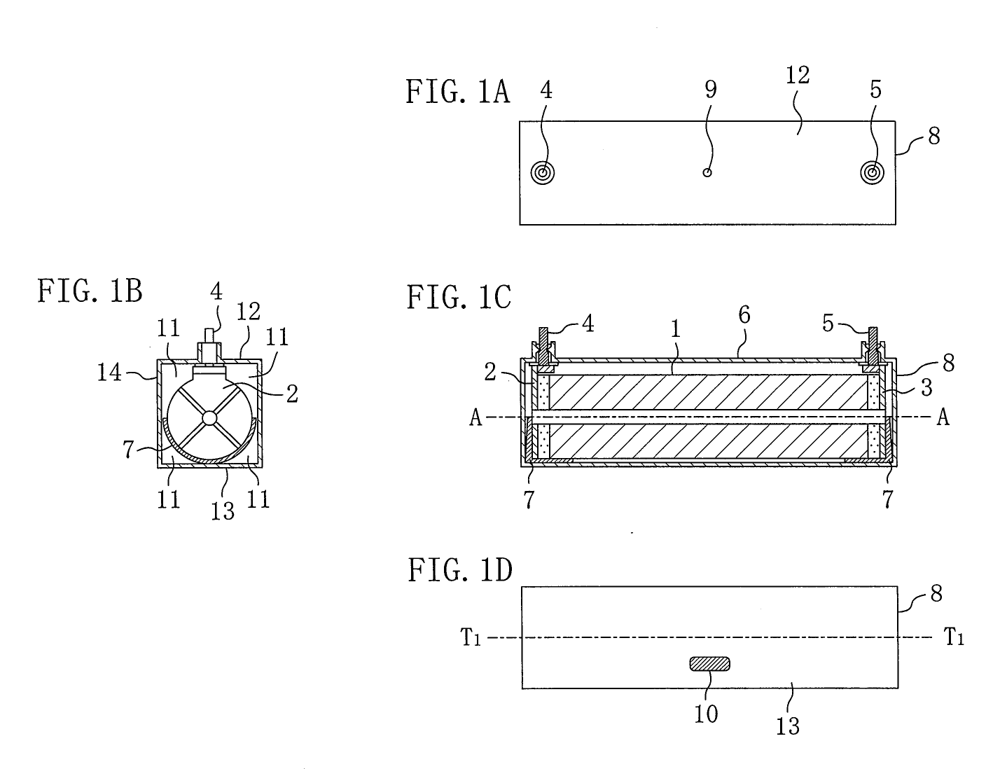

FIGS. 1A to 1D are schematic views illustrating the structure of an enclosed battery according to the embodiment of the present invention. FIG. 1A is a top view, FIG. 1B is a front perspective view, FIG. 1C is a side perspective view and FIG. 1D is a bottom view.

As shown in FIG. 1B, a cylindrical electrode group 1 prepared by winding a positive electrode and a negative electrode with a separator interposed therebetween is placed in a rectangular battery case 8 together with an electrolyte. A pressure release mechanism 10 is provided on a bottom surface 13 of the battery case 8 parallel to a winding axis A-A of the electrode group 1. As shown in FIG. 1D, the pressure release mechanism 10 is spaced apart from a projection line T₁-T₁ of the winding axis A-A of the electrode group 1 projected at a right angle on the bottom surface 13 of the battery case 8.

As shown in FIG. 1B, a region 11 defined between the cylindrical electrode group 1 and side surfaces 12, 13 and 14 (inner surfaces) of the battery case 8 parallel to the winding axis A-A of the electrode group forms empty space. In general, the electrode group 1 is elongated along the winding axis A-A. Therefore, the region 11 forms empty space large enough to ensure a working pressure for actuating the pressure release mechanism 10 when an abnormal event occurs. Accordingly, the pressure release mechanism 10 is provided on the side surface (the bottom surface 13 in the present embodiment) of the battery case 8 corresponding to the region 11, i.e., on the side surface of the battery case 8 parallel to the winding axis A-A of the electrode group 1, to be spaced apart from the projection line T₁-T₁ of the winding axis A-A of the electrode group 1 projected on the side surface of the battery case 8. As a result, gas generated in the battery due to the abnormal event can surely and quickly be emitted out of the battery.

According to the present embodiment, an electrode terminal 4 connected to a positive electrode current collector plate 2 and an electrode terminal 5 connected to a negative electrode current collector plate 3 are provided on one of the side surfaces of the battery case 8 parallel to the winding axis A-A of the electrode group 1, i.e., the top surface (a first surface) 12, as shown in FIG. 1B. In general, when a battery is loaded on a device or an electric car, the surface of the battery case 8 on which the electrode terminals 4 and 5 are provided is regarded as the top surface 12. Therefore, by providing the pressure release mechanism 10 on the bottom surface 13 (the surface facing the top surface 12), the gas generated in the battery due to the abnormal event is quickly emitted out of the battery, and at the same time, an electrolyte remaining in the battery is quickly drained out of the battery.

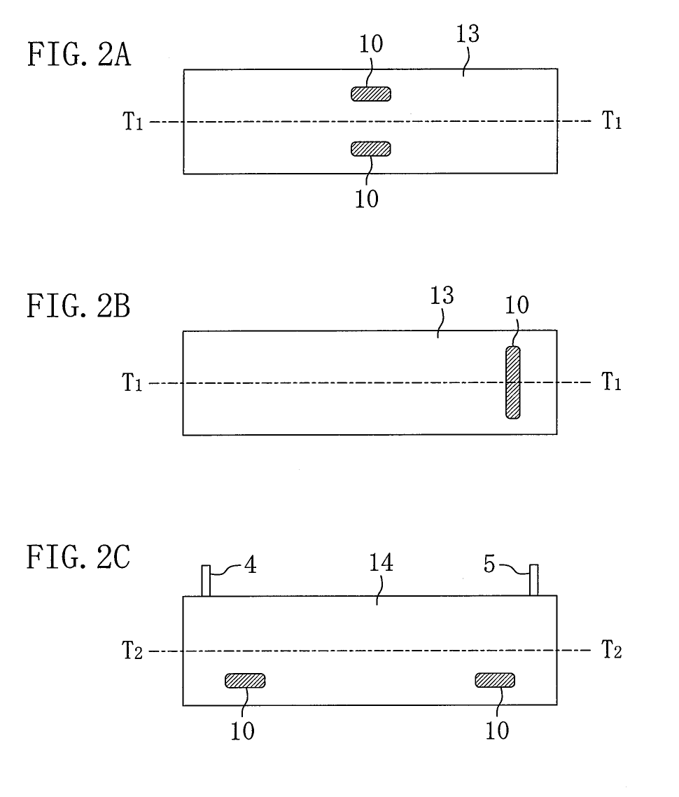

The position of the pressure release mechanism 10 is not limited to that shown in FIG. 1D. The position and number of the pressure release mechanism 10 may optionally be determined as long as the pressure release mechanism 10 is spaced apart from the projection line T₁-T₁. For example, as shown in FIG. 2A, two pressure release mechanisms 10 may be provided on the bottom surface 13 so that they face each other with the projection line T₁-T₁ interposed therebetween. Alternatively, as shown in FIG. 2B, the pressure release mechanism 10 may be provided on the bottom surface 13 to intersect with and extend vertically across the projection line T₁-T₁.

When the pressure release mechanism 10 is provided on the side surface 14 adjoining to the top surface 12, the pressure release mechanism 10 may be disposed on the side surface 14 of the battery case 8 to be spaced apart from a projection line T₂-T₂ of the winding axis A-A of the electrode group 1 projected on the side surface 14 in a direction opposite the top surface 12 (i.e., toward the bottom surface 13) as shown in FIG. 2C. With this arrangement, an electrolyte remaining near the bottom of the battery may be drained out of the battery when the gas generated in the battery when the abnormal event occurs is emitted out of the battery.

The shape of the cylindrical electrode group 1 of the present embodiment is not limited to that shown in FIG. 1B. The electrode group 1 may be in the shape of a flattened cylinder. In this case, distance between the pressure release mechanism 10 and the projection line T₁-T₁ is preferably longer than distance between them of the electrode group 1 which is cylindrical but not flattened. In this way, the pressure release mechanism 10 is arranged near the region 11 forming larger empty space. Therefore, the gas generated in the battery due to the abnormal event can quickly be emitted out of the battery.

A rectangular battery case 8 according to the present embodiment is not limited to the rectangular shape shown in FIG. 1B, but may be polygonal. In this case, the pressure release mechanism 10 is spaced apart from the projection line of the winding axis A-A of the electrode group 1 projected on the side surface of the battery case 8. As a result, the gas generated in the battery due to the abnormal event is surely and quickly emitted out of the battery.

The specific structure of the enclosed battery according to the present embodiment is explained in detail with reference to FIGS. 1A to 1D.

The electrode group 1 prepared by winding the positive and negative electrodes with the separator interposed therebetween is connected to the positive electrode current collector plate 2 on the left side and to the negative electrode current collector plate 3 on the right side. The positive and negative electrode current collector plates 2 and 3 are insulated from each other by an insulator 7 so that a short circuit does not occur in the battery case 8 made of a lid 6 and a casing. A positive electrode terminal 4 is connected to the positive electrode current collector plate 2 and a negative electrode terminal 5 is connected to the negative electrode current collector plate 3. The electrode terminals 4 and 5 protrude from the lid 6 placed on the top surface. The lid 6 and the casing are welded together. The positive and negative electrode terminals 4 and 5 are sealed to the lid 6. An injection hole 9 is closed after the electrolyte is poured in the battery case. Therefore, space inside the battery is kept enclosed.

A safety valve (pressure release mechanism) 10 which is broken when the pressure in the battery reaches a predetermined level is provided on the bottom surface of the battery case 8. The safety valve 10 is arranged so that it overlaps at least partially with the empty space 11 defined between the electrode group 1 and the inner surfaces of the battery case 8.

In nonaqueous electrolyte secondary batteries such as lithium ion secondary batteries, a highly volatile and flammable electrolyte is used, for example, cyclic carbonate or open-chain carbonate. To obtain enough long battery life, the amount of the electrolyte added in the battery is slightly larger than the maximum amount of the electrolyte that can penetrate into the electrode group 1. When an abnormal event such as an internal short circuit occurs in the thus-prepared enclosed battery, heat generation and accompanying evaporation of the electrolyte increasingly raise the pressure in the battery. In this case, the safety valve 10 arranged to partially overlap the empty space 11 makes it possible to quickly emit the gas out of the battery and efficiently drain the electrolyte remaining in the battery out of the battery when the abnormal event occurs.

The safety valve 10 may be formed by thinning or engraving, for example, and designed so as to be broken when a predetermined pressure is applied. The safety valve 10 may be replaced with a pressure regulating valve or a check valve.

The positive electrode is composed of a positive electrode material mixture containing a positive electrode active material and a positive electrode current collector made of foil. Examples of the positive electrode active material may include composite oxides such as lithium cobaltate and modified lithium cobaltate (a eutectic with aluminum or magnesium), lithium nickelate and modified lithium nickelate (in which nickel is partially substituted with cobalt or aluminum), lithium manganate and modified lithium manganate.

To the positive electrode active material, a conductive agent (e.g., acetylene black, Ketjen black, various kinds of graphites and the like), a binder (e.g., polytetrafluoroethylene (PTFE), polyvinylidene fluoride (PVdF) and the like), and a thickener (if necessary) are mixed and the mixture is kneaded with water or an organic solvent to prepare positive electrode material mixture slurry. Then, the positive electrode material mixture slurry is applied to the positive electrode current collector such as aluminum foil and dried to form a positive electrode material mixture layer. At this time, the positive electrode material mixture layer is not formed on at least one long side end of the positive electrode so that the end is left uncoated. Then, the thickness of the positive electrode material mixture layer is adjusted by pressing as required and cut into a desired dimension to prepare the positive electrode.

The negative electrode is composed of a negative electrode material mixture containing a negative electrode active material and a negative electrode current collector made of foil. Examples of the negative electrode active material may include various natural graphites, artificial graphites and alloy materials.

To the negative electrode active material, a binder (e.g., styrene-butadiene rubber (SBR), PVdF and the like) and a thickener (if necessary) are mixed and the mixture is kneaded with water or an organic solvent to prepare negative electrode material mixture slurry. Then, the negative electrode material mixture slurry is applied to the negative electrode current collector such as copper foil and dried to form a negative electrode material mixture layer. At this time, the negative electrode material mixture layer is not formed on at least one long side end of the negative electrode so that the end is left uncoated. Then, the thickness of the negative electrode material mixture layer is adjusted by pressing as required and cut into a desired dimension to prepare the negative electrode.

The separator may be an electrolyte-retentive microporous film made of a material capable of being stable at both potentials of the positive and negative electrodes (e.g., polypropylene, polyethylene, polyimide, polyamide and the like).

In preparing the electrode group 1, the uncoated portions of the positive and negative electrodes are arranged at the opposite ends of the electrode group 1 so that the uncoated portion of the positive electrode is connected to a positive electrode current collector plate (e.g., aluminum) 2 and the uncoated portion of the negative electrode is connected to a negative electrode current collector plate (e.g., copper or nickel) 3. The positive and negative electrodes are connected to the positive and negative electrode current collector plates 2 and 3 by laser welding, ultrasonic welding or the like.

### EXAMPLES

Hereinafter, the present invention is explained in detail by way of examples.

### (Battery A)

To a NiSO₄ aqueous solution, Co sulfate and Al sulfate were added in the molar ratio of Ni:Co:Al=7:2:1 to prepare a saturated aqueous solution. To the saturated aqueous solution being stirred, a sodium hydroxide solution was added dropwise to neutralize the saturated aqueous solution. As a result of this coprecipitation, a ternary precipitate represented by Ni_{0.7}Co_{0.2}Al_{0.1}(OH)₂ was produced. The precipitate was filtered, washed with water and dried at 80° C. to obtain composite hydroxide. An average particle diameter of the obtained composite hydroxide was 10 μm.

The composite hydroxide was heated in an atmospheric air at 900° C. for 10 hours to obtain ternary composite oxide represented by Ni_{0.7}Co_{0.2}Al_{0.1}O. Lithium hydroxide monohydrate was added thereto to equalize the atomic numbers of Ni, Co and Al with the atomic number of Li and then heat treatment was performed in the air at 800° C. for 10 hours to obtain lithium-nickel composite oxide represented by LiNi_{0.7}Co_{0.2}Al_{0.1}O₂. The obtained lithium-nickel composite oxide was ground and classified to obtain a positive electrode active material having an average particle diameter of 9.5 μm and a specific surface area of 0.4 m²/g.

Positive electrode slurry was prepared by kneading 3 kg of the positive electrode active material, 90 g of acetylene black, 1000 g of a PVdF solution and a proper amount of N-methyl-2-pyrrolidone (NMP). The positive electrode slurry was applied to aluminum foil of 15 μm in thickness and 150 mm in width, while a 10 mm wide portion of the foil from one long side end thereof was left uncoated with the slurry, and then dried. Then, the foil was pressed to adjust its total thickness to 100 μm and cut into a piece having a 10 mm wide uncoated portion and a 110 mm wide coated portion. Thus, a positive electrode was prepared.

Negative electrode slurry was prepared by kneading 3 kg of artificial graphite as a negative electrode active material, 75 g of styrene-butadiene copolymer rubber particles as a binder (a solid content weight was 40 wt %), 30 g of carboxymethyl cellulose (CMC) as a thickener and a proper amount of water. The negative electrode slurry was applied to copper foil of 10 μm in thickness and 150 mm in width, while a 10 mm wide portion of the foil from one long side end thereof was left uncoated with the slurry, and then dried. Then, the foil was pressed to adjust its total thickness to 110 μm and cut into a piece having a 10 mm wide uncoated portion and a 114 mm wide coated portion. Thus, a negative electrode was prepared.

The thus-prepared positive and negative electrodes were wound into a cylindrical shape with a polyethylene separator interposed therebetween and the positive and negative electrode current collectors exposed at the ends of the cylinder, respectively. Thus, an electrode group (30 mm in diameter and 80 mm in length) was prepared.

An aluminum positive electrode current collector plate was laser-welded to the end of the electrode group at which the positive electrode current collector was exposed, and a copper negative electrode current collector plate was laser-welded to the other end of the electrode group at which the negative electrode current collector was exposed. Further, a positive electrode terminal was welded to the positive electrode current collector plate and a negative electrode terminal was welded to the negative electrode current collector plate, and then the terminals were fixed to a lid. Insulators were fixed to the ends of the electrode group and the electrode group was placed in an aluminum rectangular casing provided with a 75 mm² (5×15 mm) safety valve which opens at a pressure of 10 atmospheres. The casing and the lid were laser-welded to form a battery case (35 mm width×35 mm height×90 mm length). The safety valve was provided to overlap with the entire empty space formed inside the battery case (space in which the inner surfaces of the battery case and the electrode group are not in contact), i.e., arranged as shown in FIG. 1D.

A solute of lithium hexafluorophosphate (LiPF₆) in a concentration of 1 mol/dm³ was dissolved in a solvent mixture prepared by mixing ethylene carbonate (EC) and dimethyl carbonate (DMC) in the volume ratio of 1:3 to prepare an electrolyte. Then, 30 g of the electrolyte was injected into the battery case through an injection hole formed in the lid to impregnate the electrode group with the electrolyte and the battery case was sealed. Thus, a lithium ion secondary battery having a nominal capacity of 5 Ah was prepared. After the electrolyte injection, the battery case was opened to extract an excess of the electrolyte. The weight of the excess of the electrolyte was about 10 g. This means that the electrode group in the initial state was impregnated with about 20 g of the electrolyte.

The thus-obtained lithium ion secondary battery was placed so that the surface of the battery case provided with the safety valve was regarded as a bottom surface. The obtained battery was regarded as battery A as an example of the present invention.

### (Battery B)

A lithium ion secondary battery was prepared in the same manner as the manufacture of battery A except that part of the safety valve overlapped with the electrode group (arranged as shown in FIG. 2B) and the battery was placed so that the surface of the battery case provided with the safety valve was regarded as the bottom surface. This battery was regarded as battery B as an example of the present invention.

### (Battery C)

The same lithium ion secondary battery as the battery A was prepared and places so that the surface of the battery case provided with the safety valve was regarded as the side surface. This battery was regarded as battery C as an example of the present invention.

### (Battery D)

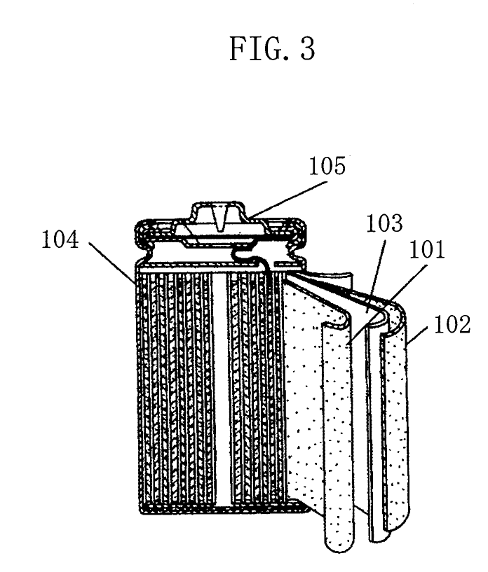

A conventional cylindrical lithium ion secondary battery as shown in FIG. 3 was fabricated (35 mm in diameter and 90 mm in length). Specifically, an electrode group (of the same size as that of the battery A) made of a positive electrode 101, a separator 103 and a negative electrode 102 which were the same as those used in the battery A was placed in a cylindrical battery case 104. Then, an electrolyte of the same amount and the same composition as that used in the battery A was injected in the battery case and a top opening of the battery case 104 was crimp-sealed by a sealing plate 105 having a safety valve of the same area as that of the battery A. Thus, a cylindrical lithium ion secondary battery having a nominal capacity of 5 Ah was prepared. The surface of the lithium ion secondary battery on which the sealing plate 105 was arranged was regarded the top surface. This battery was regarded as battery D as a comparative example.

The batteries A to D were prepared, 5 each, and examined by a nail insertion test performed under the following conditions in an environment of 25° C. First, each battery was charged at a current value of 1.0 A up to a charge end voltage of 4.2 V, and then discharged down to a discharge end voltage of 3.0 V. As a result, it was confirmed that a discharge capacity close to the nominal capacity (5 Ah) was obtained. Then, the battery was overcharged at a current value of 1.0 A up to a charge cutoff voltage of 4.4 V. The overcharged battery was fixed onto a stage and a nail having a radius of 1.5 mm is inserted into the center of a side surface.

Under the above-described conditions, the nail insertion test was performed to check the amount of the electrolyte remaining in the battery case, whether the battery case was broken or not, the degree of expansion of the battery case and the maximum battery temperature. Table 1 shows the results.

TABLE 1

| | | | | Maximum |
|---|---|---|---|---|
| | Electrolyte | | Degree of | battery |
| | remaining in | Break of | battery case | temperature |
| Battery | battery case (g) | battery case | expansion (mm) | (° C.) |
| A | 0 | Not occurred | 0.2 | 118 |
| B | 0 | Not occurred | 0.5 | 112 |
| C | 6 | Not occurred | 0.3 | 115 |
| D | 4 | Occurred | 0.1 | 125 |

In the batteries A, the safety valve was actuated and opened in a few seconds after the nail insertion and the excess amount of the electrolyte in the battery case was sprayed out of the battery. In all 5 batteries A, other parts than the safety valves were not broken. The expansion of the battery case was as very small as 0.2 mm and the electrolyte did not remain in the battery case.

In the batteries B, just like the batteries A, the excess amount of the electrolyte in the battery case was sprayed out of the battery. In all 5 batteries after the test, other parts than the safety valves were not broken and the electrolyte did not remain in the battery case. However, as compared with the batteries A, the expansion of the battery case was 0.5 mm, which was slightly larger than that observed in the batteries A. Since the safety valve was provided on part of the surface of the battery case overlapping with the electrode group and the battery case in contact with each other, gas was emitted less smoothly as compared with the battery A even when the safety valve was actuated. Therefore, it is inferred that the pressure in the battery was increased before the gas was emitted and therefore the battery case was deformed.

In the batteries C, the battery case was hardly expanded. However, the amount of the electrolyte remaining in the battery case was as large as 6 g. Although the batteries C had the empty space, the safety valve was provided on the side surface of the battery case. Therefore, the electrolyte remaining in the bottom of the battery case was not completely drained out of the battery. Nevertheless, in all 5 batteries C, other parts than the safety valves were not broken and the expansion of the batteries was very small. Thus, it is inferred that the gas was quickly emitted.

In the batteries D, the safety valve was actuated, but three battery cases were broken partially at the bottom thereof. Different from the batteries A to C, the electrode group and the battery case of the batteries C were both cylindrical. Therefore, sufficiently large space was not formed. Further, the gas was not quickly emitted out of the battery because the safety valve was provided on the upper part of the battery and the pressure increase in the battery was accelerated by the electrolyte remaining in the battery. It is inferred that the battery cases were broken for these reasons.

From the above-described results, by providing the safety valve on the surface of the battery case corresponding to the empty space defined between the cylindrical electrode group and the side surfaces of the battery case, the gas generated in the battery when an abnormal event occurs is surely and quickly emitted out of the battery. Further, as the safety valve is provided on the bottom surface of the battery case, the gas generated in the battery when the abnormal event occurs is quickly emitted out of the battery and the electrolyte remaining in the battery is quickly drained out of the battery.

The preferred embodiment of the present invention described above does not limit the present invention. As a matter of course, various modifications can be added thereto.

### INDUSTRIAL APPLICABILITY

The present invention is useful for lithium ion secondary batteries which are expected to have a high level of safety and is applicable not only to electronic devices but also to driving sources for electric tools, electric vehicles.

1. An enclosed battery comprising a cylindrical electrode group which is prepared by winding a positive electrode and a negative electrode with a separator interposed therebetween and placed in a rectangular battery case together with an electrolyte, wherein
a pressure release mechanism is provided on a side surface of the battery case parallel to a winding axis of the electrode group, and
the pressure release mechanism is disposed to be spaced apart from a projection line of the winding axis of the electrode group projected at a right angle on the side surface and corresponds to empty space defined between the electrode group and inner surfaces of the battery case.

2. The enclosed battery of claim 1, wherein
a terminal of the positive electrode and a terminal of the negative electrode are provided on a first side surface of the side surfaces of the battery case, and
the pressure release mechanism is provided on a second side surface facing the first side surface.

3. The enclosed battery of claim 2, wherein
at least two or more pressure release mechanisms are provided on the second side surface to be spaced apart from each other and face each other with the projection line interposed therebetween.

4. The enclosed battery of claim 2, wherein
the pressure release mechanism intersects with and vertically extends across the projection line on the second side surface.

5. The enclosed battery of claim 1, wherein
a terminal of the positive electrode and a terminal of the negative electrode are provided on a first side surface of the side surfaces, and
the pressure release mechanism is provided on a third side surface adjoining to the first side surface and spaced apart from the projection line projected on the third side surface in a direction opposite the first side surface.

6. The enclosed battery of claim 1, wherein the electrode group is in the shape of a flattened cylinder.

7. (canceled)

8. The enclosed battery of claim 1, wherein the pressure release mechanism is a safety valve.
